(19) United States
(12) Patent Application Publication
(10) Pub. No.: US 2016/0156951 A1
(43) Pub. Date: Jun. 2, 2016

(54) INTELLIGENT AUTO-TUNING FOR A VIDEO SERVICES SYSTEM

(71) Applicant: SLING MEDIA PVT LTD, Bangalore (IN)

(72) Inventors: Melvin P. Perinchery, Bangalore (IN); Amey Shirali, Bangalore (IN)

(21) Appl. No.: 14/557,716

(22) Filed: Dec. 2, 2014

(51) Int. Cl. H04N 21/25; H04N 21/258; H04N 21/6336; H04N 21/438; H04N 21/433; H04N 21/6543; H04N 21/442; H04N 21/458

(52) U.S. Cl. CPC H04N 21/251; H04N 21/44204; H04N 21/25891; H04N 21/458; H04N 21/4383; H04N 21/4334; H04N 21/6543; H04N 21/6336

(57) ABSTRACT

A system and related operating methods of controlling operation of a content receiver device are presented here. An exemplary operating method receives user interaction data at a recommendation system. The user interaction data corresponds to content consumption behavior of a user. The method continues by processing the user interaction data to identify recommended video events for the user. The recommendation system generates control commands to automatically configure the content receiver device to present a first recommended video event to the user.

### TECHNICAL FIELD

Embodiments of the subject matter described herein relate generally to content distribution systems, such as video services systems. More particularly, embodiments of the subject matter relate to systems and methodologies for automatically providing preferred video content to a subscriber of a video services system.

### BACKGROUND

Most television viewers now receive their video signals through a content aggregator such as a cable or satellite television provider. Digital video broadcasting (DVB) systems, such as satellite systems, are generally known. A DVB system that delivers video service to a home will usually include a video services receiver, system, or device, which is commonly known as a set-top box (STB). In the typical instance, encoded television signals are sent via a cable or wireless data link to the viewer's home, where the signals are ultimately decoded in the STB. The decoded signals can then be viewed on a television or other appropriate display as desired by the viewer.

In addition to receiving and demodulating video content (such as television programming), many video services receivers are able to provide additional features. Examples of popular features available in many modern video services receivers include electronic program guides (EPGs), digital video recorders (DVRs), “place-shifting” features for streaming received content over a network or other medium, and/or the ability to simultaneously view multiple programs showing on different channels using picture-in-picture (PIP) functionality.

A typical viewer of broadcast video services may have a handful of favorite shows or channels. Moreover, viewers tend to “channel surf” during commercial breaks in an attempt to find interesting programming. Standard video broadcasting systems may provide hundreds of different channels to end users. Unfortunately, each individual end user is still expected to select which video programs and channels to watch at any given time, and/or to choose specific programs or events that may be available as on-demand content. Thus, a user can spend a vast amount of time attempting to find interesting or favorite content for viewing.

Accordingly, it is desirable to have an intelligent video delivery system that learns the viewing preference and habits of the end user for purposes of recommending and providing content that is suited to the end user. In addition, it is desirable to have a video services receiver that can be automatically tuned to present recommended video content to the user. Furthermore, other desirable features and characteristics will become apparent from the subsequent detailed description and the appended claims, taken in conjunction with the accompanying drawings and the foregoing technical field and background.

### BRIEF SUMMARY

A method of controlling operation of a content receiver device is presented here. An exemplary embodiment of the method receives user interaction data at a recommendation system, wherein the user interaction data corresponds to content consumption behavior of a user. The method continues by processing the user interaction data to identify recommended video events for the user. Next, the recommendation system generates control commands to automatically configure the content receiver device to present a first recommended video event to the user.

Also presented is an exemplary embodiment of a video services receiver. The video services receiver includes a receiver interface to receive data associated with video services, wherein the data includes video data that conveys video events. The receiver also includes at least one decoder module to decode received video data for presentation of video events, and a display interface for a display element operatively coupled to the video services receiver. The display interface facilitates presentation of video content on the display element. The receiver also includes at least one processor device. The processor architecture cooperates with the receiver interface, the at least one decoder module, and the display interface to: provide user interaction data to a recommendation engine, the user interaction data corresponding to content consumption behavior of a user; receive control commands that identify recommended video events for the user; and in response to the received control commands, automatically configure the at least one decoder module to present a first recommended video event to the user.

Another method of controlling operation of a content receiver device is presented here. The method provides user interaction data to a recommendation engine, wherein the user interaction data corresponds to content consumption behavior of a user. The method continues by processing the user interaction data to identify a recommended video event for the user, and by communicating control data from the recommendation engine to the content receiver device. The control data is associated with the recommended video event such that, the content receiver device is automatically configured in response to the received control data to present the recommended video event.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an embodiment of a video services system;

FIG. 2 is a simplified schematic representation of an embodiment of a video services receiver suitable for use in the system shown in FIG. 1;

FIG. 3 is a flow diagram that illustrates an exemplary embodiment of an intelligent video channel auto-tuning process; and

FIG. 4 is a diagram that depicts several sources of user interaction data that can feed the recommendation system shown in FIG. 1.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The exemplary embodiments described below relate to a video delivery system such as a satellite television system. The disclosed subject matter relates to the automatic presentation of recommended content (for example, video events) to a user of the system. The system includes or cooperates with a recommendation system that utilizes a recommendation engine or algorithm to intelligently learn the user's preferences, viewing habits, likes, dislikes, etc. The recommendation system considers a set of user interaction data to select recommended content for the user, and automatically configures a video presentation device or a video services receiver so that the recommended content can be provided to the user with little to no involvement on behalf of the user.

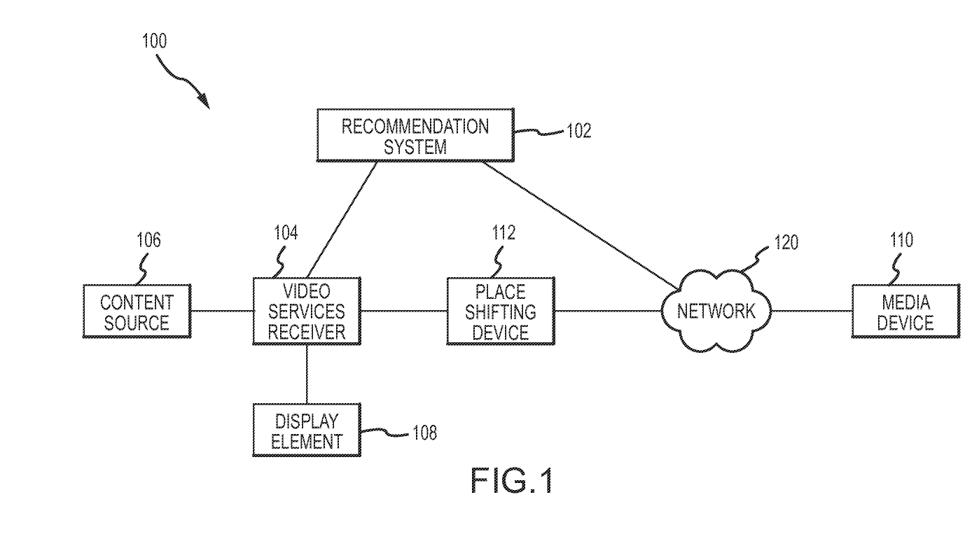

Turning now to the drawings, FIG. 1 is a schematic representation of an embodiment of a video services system 100 that is suitably configured to support the techniques and methodologies described in more detail below. Depending on the embodiment, the system 100 may be implemented as a satellite video services system, a cable video services system, a cellular-based content delivery system, an Internet-based content delivery system, a combination thereof, or the like. In some implementations, the system 100 supports traditional linear content delivery technologies such as those utilized by cable and satellite broadcast services. Alternatively or additionally, non-linear content delivery technologies can be leveraged. Non-linear technologies include, without limitation, Internet Protocol Television (IPTV), Over-The-Top (OTT) content delivery, on-demand content, and the like.

The system 100 (which has been simplified for purposes of illustration) generally includes, without limitation: a recommendation system 102; a content receiver device, such as a video services receiver 104; at least one content source 106; and a display element 108 associated with the video services receiver 104. The system 100 may include or support a media device 110 that is owned or operated by a user of the system 100. Although not always required, the system 100 may also include a place-shifting device 112 associated with the video services receiver 104. For the sake of brevity, conventional techniques related to satellite communication systems, satellite broadcasting systems, DVB systems, data transmission, signaling, network control, and other functional aspects of the systems (and the individual operating components of the systems) may not be described in detail herein.

For simplicity, FIG. 1 only shows one content source 106. An embodiment of the system 100, however, may include or cooperate with any number of content sources (which may be co-located or geographically distributed). Moreover, a given video services provider (e.g., a satellite video provider, a cable television provider, a telecommunication services provider, or the like) could maintain, provide, or otherwise cooperate with any number of content sources 106 designed to support any number of subscribers.

In certain embodiments, the content source 106 may be deployed as a head end facility and/or a satellite uplink facility for the system 100. In some embodiments, the content source 106 may include or cooperate with one or more web-based content delivery applications, services, or providers. In yet other embodiments, the content source 106 may be associated with a cellular service provider such that the content source 106 can deliver media to cellular devices or other types of mobile devices. Regardless of its implementation, the content source 106 is suitably configured to provide media content (e.g., broadcast video content, recorded video content, on-demand video content, audio content, image content, multimedia content, or the like) to end users of the system 100.

For the illustrated embodiment, the content source 106 provides media content to the video services receiver 104. The video services receiver 104 represents an end user device that is suitably configured to support decoding and presentation of video content (e.g., video events, video programming, and the like) conveyed in data provided by the content source 106. In this regard, the video services receiver 104 may be realized using any number of device platforms, as appropriate for the particular embodiment. Accordingly, the video services receiver 104 can be realized as any device, system, or apparatus that is capable of receiving signals from the content source 106, decoding or otherwise processing data that conveys media content, and formatting the decoded data for presentation (display) to the user. In practice, the video services receiver 104 may be realized as any of the following, without limitation: a set-top box for a satellite or cable television system; a desktop, laptop, or tablet computer device; a television set or monitor; a video game system; a digital video recorder; a CD or DVD player; a piece of home entertainment equipment; a smart appliance; a mobile telephone; an electronic navigation device; a digital media player device; or an onboard vehicle-based entertainment system.

This description relates to a video services implementation where the content source 106 provides video programming on a plurality of channels. In such an implementation, the video services receiver 104 receives programming data, signaling information, and/or other data as needed. The video services receiver 104 then demodulates, decompresses, descrambles, and/or otherwise processes the received digital data (if authorized to do so), and then converts the received data to suitably formatted video signals that can be rendered for viewing by the customer on the display element 108.

In some embodiments, the place-shifting device 112 converts video programming into a packet-based format for communication over a network 120 (such as the Internet) to the media device 110. Upon receipt, the media device 110 uses its native media player functionality and/or web browser functionality to render the place-shifted video content to the user. The network 120 also allows a user of the media device 110 to remotely control the operation of the video services receiver 104 to change channels, select video events, configure the place-shifting device 112, etc.

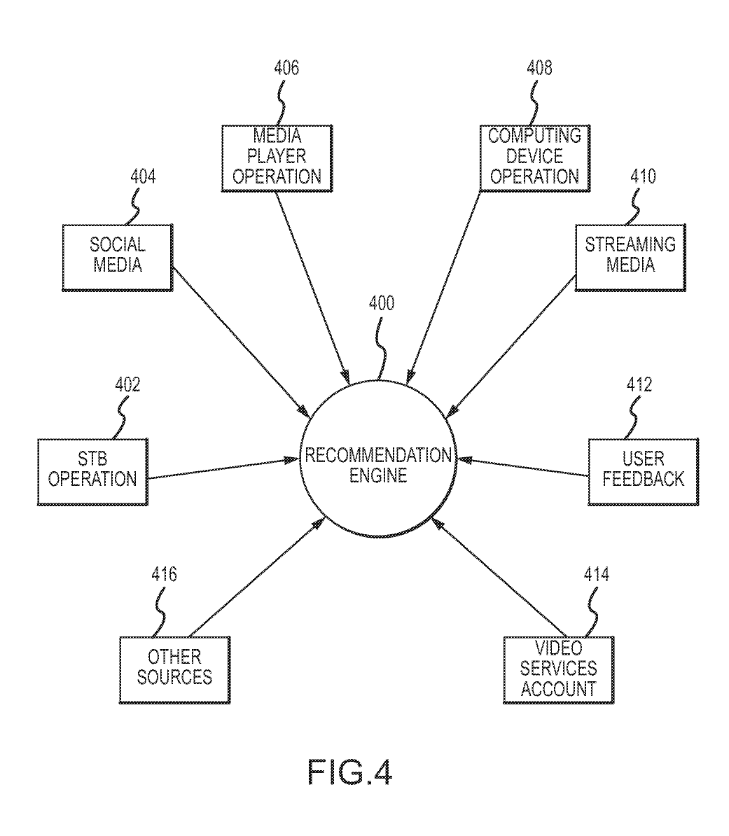

The recommendation system 102 includes suitably configured processing logic and intelligence that enables it to receive and analyze information that may be indicative of the user's viewing habits, viewing preferences, likes, dislikes, preferred programming, favorite video events, and the like. To this end, the recommendation system 102 can communicate with the video services receiver 104 for purposes of obtaining user interaction data associated with the operation of the video services receiver 104. The recommendation system 102 also communicates or otherwise interacts with the video services receiver 104 to automatically control and configure the video services receiver 104 as needed to present recommended content to the user. As shown in FIG. 1, the recommendation system 102 can utilize the network 120 to obtain user interaction data related to the operation of the media device 110. Moreover, communication with the network 120 allows the recommendation system 102 to obtain and process user interaction data from any number of devices, systems, or sources if so desired (as described in more detail below with reference to FIG. 4).

FIG. 1 depicts the recommendation system 102 and the video services receiver 104 as distinct and separate blocks. In certain embodiments, however, the recommendation system 102 (or its functionality) can be integrated into the video services receiver 104. Alternatively or additionally, the recommendation system 102 or its functionality can be incorporated into the place-shifting device 112. Alternatively or additionally, the recommendation system 102 or its functionality can be integrated into the media device 110. Moreover, the operation of the recommendation system 102 can be distributed in certain embodiments of the system, such that a plurality of different components cooperate to achieve the desired functionality. These and other possible implementations are contemplated by this disclosure.

For simplicity and ease of understanding, only one video services receiver 104 is shown in communication with the recommendation system 102. In practice, however, a centralized recommendation system 102 can support any number of users/subscribers and any number of video services receivers. Moreover, the recommendation system 102 may communicate with any number of media devices 110, computing devices, third party services, applications, and systems, and the like. In this regard, a centralized recommendation system 102 can be deployed to analyze user interaction data collected on behalf of many individuals and generate content recommendations for each end user, for a group of end users, for a geographical region, or the like.

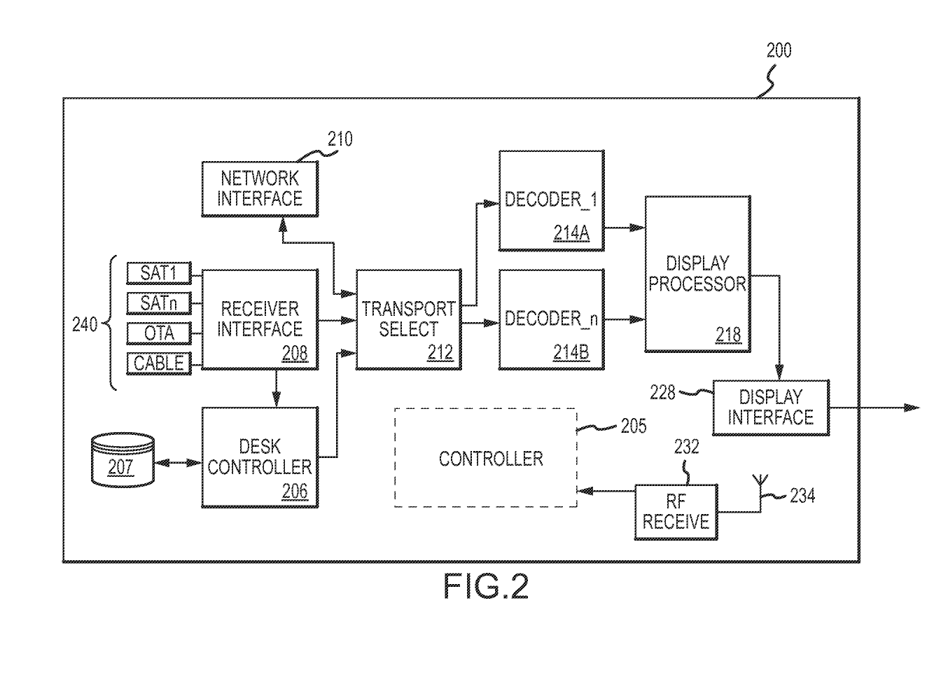

Although a variety of implementations are contemplated by this disclosure, the following example assumes that the video services receiver 104 is realized as a set-top box that is intended for deployment at a customer premises, e.g., the user's home. In this regard, FIG. 2 is a simplified schematic representation of an embodiment of a video services receiver 200 suitable for use in the system shown in FIG. 1. The illustrated video services receiver 200 may represent one suitable embodiment of the video services receiver 104 shown in FIG. 1. This particular embodiment generally includes, without limitation: a receiver interface 208, a plurality of decoder modules 214, and a display processor module 218, as appropriate. FIG. 2 also shows a disk controller interface 206 to a disk or other storage device 207, a network interface 210 to a local or wide area network, a transport select module 212, a display interface 228 for a display element, an RF receiver module 232, and a controller 205, which may be implemented as control logic executed by a processor architecture having at least one processor device. Other embodiments may incorporate additional or alternate processing modules from those shown in FIG. 2, may omit one or more modules shown in FIG. 2, and/or may differently organize the various modules in any other manner different from the exemplary arrangement shown in FIG. 2.

The video services receiver 200 may be physically and logically implemented in any manner. FIG. 2 shows various logical and functional features that may be present in an exemplary device, wherein each module shown in the figure may be implemented with any sort of hardware, software, firmware, and/or the like. In this regard, the video services receiver 200 may include a processor architecture having at least one processor device that cooperates with the various modules, elements, and devices of the video services receiver 200 to support the features and functions described herein. Any of the various processing modules may be implemented with any sort of general or special purpose integrated circuitry, for example, such as any sort of microprocessor, microcontroller, digital signal processor, programmed array and/or the like. Any number of the modules shown in FIG. 2, for example, may be implemented as a “system on a chip” (SoC) using any suitable processing circuitry under control of the controller 205. In various embodiments, the control logic of the controller 205 executes within an integrated SoC or other processor that implements the receiver interface 208, the transport select module 212, the decoder module 214, the display processor module 218, the disk controller interface 206, and/or other features, as appropriate. In still other embodiments, various distinct chips, circuits or components may be interconnected with each other to implement the receiving and decoding functions represented in FIG. 2.

Various embodiments of the video services receiver 200 therefore include any number of appropriate modules for obtaining and processing media content (which may include video content, audio content, audiovisual content, still images, graphics, advertisements, posters or screens related to program events, or the like) as desired for the particular embodiment. Each of these modules may be implemented in any combination of hardware and/or software using logic executed within any number of semiconductor chips or other processing logic.

Various embodiments of the controller 205 can include any circuitry, components, hardware, software and/or firmware logic capable of controlling the various components of the video services receiver 200. Various routines, methods and processes executed within the video services receiver 200 are typically carried out under the control of the controller 205, as described more fully below. Generally speaking, the controller 205 receives user input signals via the RF receiver module 232, which in turn communicates with a remote control device (not shown) using a suitable antenna 234. The controller 205 receives user inputs from the remote control device 113 and/or any other source, and directs the other components of the video services receiver 200 in response to the received inputs to present the desired imagery on a display element.

As noted above, many embodiments of the video services receiver 200 include a receiver interface 208, which is any hardware, software, firmware and/or other logic capable of receiving data associated with video services (e.g., media content data) via one or more content sources 240. In various embodiments, the content sources 240 may include any number of cable television, DBS, broadcast and/or other programming sources as appropriate. Although not separately depicted in FIG. 2, the receiver interface 208 may include or cooperate with a plurality of tuners that are configured to receive the content data from the content sources 240. For example, in a satellite video system, the receiver interface 208 may include a plurality of tuners to enable the video services receiver 200 to receive data from a plurality of satellite transponders.

The receiver interface 208 appropriately selects a desired input source and provides the received content to an appropriate destination for further processing. In various embodiments, received programming may be provided in real-time (or near real-time) to a transport select module 212 or other component for immediate decoding and presentation to the user. Alternatively, the receiver interface 208 may provide content received from any source to a disk or other storage medium in embodiments that provide DVR functionality. In such embodiments, the video services receiver 200 may also include a disk controller interface 206 that interacts with an internal or external hard disk, memory and/or other storage device 207, which may be suitably configured to store recorded video content in an appropriate database structure.

In the embodiment shown in FIG. 2, the video services receiver 200 also includes an appropriate network interface 210, which operates using any implementation of protocols or other features to support communication by the video services receiver 200 on a network. In various embodiments, the network interface 210 supports conventional LAN, WAN or other protocols (e.g., the TCP/IP or UDP/IP suite of protocols widely used on the Internet) to allow the video services receiver 200 to communicate on the Internet or any other network as desired. The network interface 210 typically interfaces with the network using any sort of LAN adapter hardware, such as a conventional network interface card (NIC) or the like provided within the video services receiver 200. The network interface 210 enables the video services receiver 200 to provide user interaction data to a network-based recommendation system 102 if necessary (see FIG. 1).

The transport select module 212 is any hardware and/or software logic capable of selecting a desired media stream from the available sources. In the embodiment shown in FIG. 2, the transport select module 212 is able to generate video signals for presentation on one or more output display interfaces 228. Typically, the transport select module 212 responds to viewer inputs (e.g., via the controller 205) to simply switch encoded content received from a broadcast, satellite, cable or other content source 240 or from the storage device 207 to one or more decoder modules 214.

The video services receiver 200 may include a plurality of decoder modules 214 for decoding, decompressing, and/or otherwise processing received/stored content as desired. Generally speaking, the decoder modules 214 decompress, decode, and/or otherwise process received content from the transport select module 212 to extract an MPEG or other media stream encoded within the stream. The decoded content can then be processed by one or more display processor modules 218 to create a presentation on a display element for the viewer in any appropriate format. FIG. 2 shows two decoder modules 214A, 214B operating on two separate signals from the transport select module 212. The two decoder modules 214A, 214B allow the video services receiver 200 to provide and present two distinct and separate video streams concurrently on one display element. In practice, any number of decoder modules 214 may be used, particularly in situations where multiple signals are simultaneously decoded and displayed. Accordingly, the term “decoder” may collectively apply to one or more decoder modules that are able to decode one or more signals for presentation on the display element.

The display processor module 218 includes any appropriate hardware, software and/or other logic to create desired screen displays via the display interface 228 as desired. Such displays may include combining signals received from one or more of the decoder modules 214 to facilitate presentation and viewing of one or more channels of video content on a display element. In various embodiments, the display processor module 218 is also able to produce on screen displays (OSDs) for an interactive EPG, setup and control functions, input/output facilitation, and/or other features that may vary from embodiment to embodiment. Such graphical displays are not typically contained within the received or stored broadcast stream, but are nevertheless useful to users in interacting with the video services receiver 200. The generated displays, including received/stored content and any other displays may then be presented to one or more output display interfaces 228 in any desired format.

The display processor module 218 produces an output signal encoded in any standard format (e.g., ITU656 format for standard definition television signals or any format for high definition television signals) that can be readily converted to standard and/or high definition television signals at the display interface 228. In other embodiments, the functionality of the display processor module 218 and the display interface 228 may be combined in any manner.

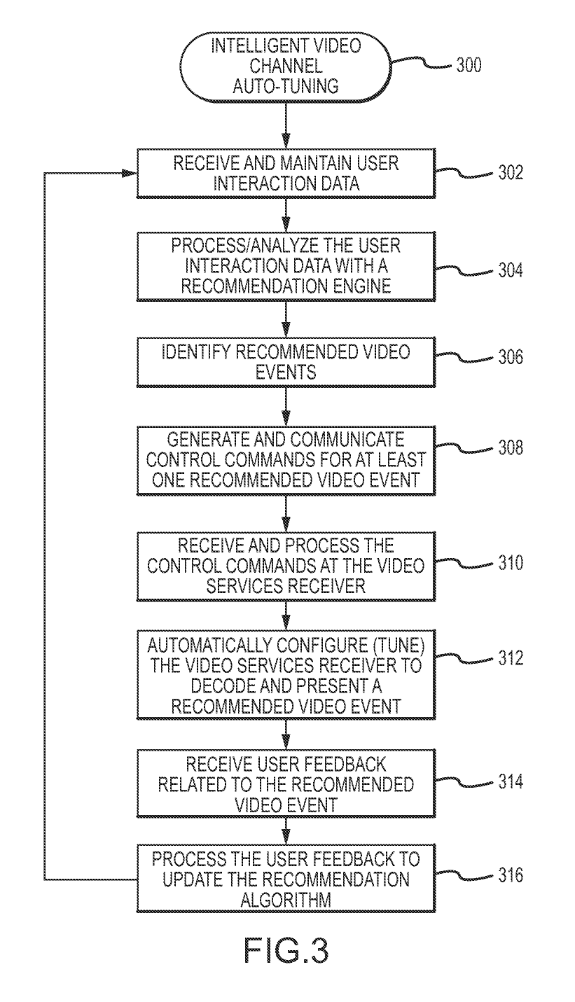

FIG. 3 is a flow diagram that illustrates an exemplary embodiment of an intelligent video channel auto-tuning process 300. The process 300 represents an exemplary embodiment of a method of controlling the operation of a content receiver device, such as a set-top box of a video delivery system. The various tasks performed in connection with the process 300 may be performed by software, hardware, firmware, or any combination thereof. For illustrative purposes, the following description of the process 300 may refer to elements mentioned above in connection with FIGS. 1-2. In practice, portions of the process 300 may be performed by different elements of the described system, e.g., a video services receiver, a recommendation system, a media player device, or the like. It should be appreciated that the process 300 may include any number of additional or alternative tasks, the tasks shown in FIG. 3 need not be performed in the illustrated order, and the process 300 may be incorporated into a more comprehensive procedure or process having additional functionality not described in detail herein. Moreover, one or more of the tasks shown in FIG. 3 could be omitted from an embodiment of the process 300 as long as the intended overall functionality remains intact.

The process 300 receives and maintains user interaction data (task 302) at a recommendation system, at a recommendation module or engine that resides at a suitably configured device or component, or at any suitably configured system, device, subsystem, component, or processing module. For the exemplary embodiment described here in the context of the process 300, the user interaction data is obtained and collected by a cloud-based recommendation system (such as the recommendation system 102 depicted in FIG. 1) that communicates with one or more sources of the user interaction data via wireless and/or wired data communication network technologies. In alternative implementations, the user recommendation data can be received and processed by a recommendation engine or processing module resident at a video services receiver (e.g., a set-top box in the user premises). In other embodiments, the user recommendation data can be obtained at a mobile device that is owned or operated by the user (e.g., a smartphone, a media player device, a video game device, a tablet or laptop computing device, or a vehicle-based entertainment system).

The user interaction data corresponds to, or is otherwise associated with, certain content consumption behavior, viewing statistics, and/or viewing habits of: a particular user; a group of users; a user's household or workplace; a geographic region or territory in which the user is located; a demographic classification or category of which the user is a member; or the like. In this regard, the user interaction data is indicative or predictive of media content preferences, likes, dislikes, trends, and/or favorites of the user. To this end, the user interaction data may originate at one source or a variety of different sources. For example, a simple implementation of the process 300 can rely on user interaction data that is collected or provided by a content receiver device (such as a set-top box), wherein the collected user interaction data includes usage data related to the operation of the content receiver device. For such an implementation, the user interaction data may include, without limitation: favorite channels configured by the user; statistics related to which channels are frequently/infrequently watched; the history of on-demand programs purchased or viewed; statistics related to which programs (e.g., video events) are frequently/infrequently watched; the history of programs that have been recorded; etc. As another example, a more complex version of the process 300 can consider user interaction data that originates from a plurality of different sources, and in the context of a plurality of different users.

FIG. 4 is a diagram that depicts several sources of user interaction data that can feed the recommendation system 102, or any suitably deployed recommendation engine 400, regardless of where the engine 400 is realized. As mentioned previously, the recommendation engine 400 can be implemented at a video services receiver, at a cloud-based component, at a mobile user device, or the like. FIG. 4 is a simple diagram that schematically illustrates how the recommendation engine 400 can obtain user interaction data from any number of independent or disparate sources. Exemplary sources and types of user interaction data include, without limitation: usage data (402) related to the operation of a video services receiver or set-top box; social media data (404) related to the user's social media activity and usage; media player data (406) related to the operation of a media device owned or otherwise associated with the user; computing device data (408) related to the operation of a computing device or system owned or otherwise associated with the user; streaming media data (410) related to the user's streaming media activity and usage; user feedback data (412) related to content recommendations previously made by the recommendation engine 400; user account data (414) related to the user's video services subscription; and other potential sources (416) that are not explicitly mentioned here.

The recommendation system/engine can receive the user interaction data from one or more sources, depending on the type and origin of the user interaction data. For example, the recommendation system/engine can obtain or receive the usage data 402 from a content receiver device such as a video services set-top box. As another example, the recommendation system/engine can receive or acquire the media player data 406 directly from a media device that is operated by the user. Likewise, the recommendation system/engine can receive computing device data 408 that originates from a computer (desktop, laptop, tablet, or other form factor) that is operated by the user. The streaming media data 410 can be provided by one or more streaming media services that are utilized by the user. For instance, the user may be a subscriber to a streaming music service and a streaming video service; the recommendation system/engine can receive subscriber data that identifies the content preferred by the user. Similarly, the social media data 404 can be provided by one or more social media services or applications utilized by the user. In this regard, the recommendation system/engine can receive information related to the user's posted content, social graph, people followed by the user, the user's followers, content “liked” by the user, content shared by the user, and the like.

The user interaction data received and handled by the recommendation engine 400 need not be exclusive to any one individual user. In this regard, the recommendation engine 400 can monitor, receive, and maintain user interaction data for a plurality of different users for purposes of making recommendations and suggestions. Thus, the process 300 can generate recommendations for an individual user based on the viewing habits and interaction of any number of users. For example, the process 300 can generate citywide recommendations, recommendations for a neighborhood or zip code, recommendations for an area code, recommendations for a family or extended family, a designated group of individuals, or the like. For simplicity and ease of understanding, this description focuses on an exemplary embodiment that generates content recommendations for an individual based on user interaction data that involves that particular individual.

Referring again to FIG. 3, the recommendation system processes and analyzes at least a portion of the received user interaction data in accordance with an appropriate recommendation algorithm (task 304). Task 304 may involve processing logic or intelligence that learns or predicts user preferences, likes, and desires based on the analyzed user interaction data. Depending on the particular implementation, the recommendation system can employ any suitably configured learning algorithm, expert system, artificial intelligence methodology, and/or prediction technique to identify recommended content (e.g., video events) for the user (task 306). Thus, recommended video programming can be determined based on some or all of the received user interaction data, collected over any historical period of time. For example, if the user interaction data reveals that the user typically enjoys sporting events or sport-related movies, then the recommendation system can be biased toward similar sports-centric content. As another example, if the user interaction data shows that the user has several favorite actors, then the recommendation system can generate ongoing recommendations of content that feature those favorite actors. As yet another example, if the user interaction data reveals that the user is particularly interested in cooking or food-related programming, then the recommendation system can generate recommendations that fall within the same or a similar programming genre. As mentioned above, the recommended video events can be based on the interaction data of any individual user, or it can be based on the user's actual interaction data along with additional user interaction data that represents the content consumption behavior of at least one additional user.

The process 300 can identify the recommended video events using any desired scheme or notation. In certain embodiments, recommended video events are identified by a code or string, which in turn may be linked to a particular program title that will be broadcast on a designated channel or service at a specific time slot. As another example, the process 300 can leverage electronic program guide (EPG) data that is commonly used to convey video programming content to be broadcast by a video services provider. These and other content identification methodologies are contemplated by this description.

The process 300 continues by generating and communicating appropriate control commands that are intended to automatically control and configure a content receiver device, e.g., a video services set-top box (task 308). More specifically, the control commands are intended to automatically tune the destination device to present at least one recommended video event. Accordingly, the control commands may convey identifiers that designate the recommended video events, wherein the identifiers are compatible with the destination device. This allows a destination video services receiver to receive and process the control commands in an appropriate manner (task 310). In this regard, the video services receiver automatically responds to the received control commands by tuning to the designated channel and decoding the identified video event for presentation at the user's presentation device (task 312). Notably, task 312 can be performed in a seamless manner with little to no user involvement; this results in recommended content being pushed to the user in a way that does not require the user to search for the content, and in a way that does not rely on “channel surfing” or program guide consultation. In alternative embodiments, the video services receiver or the user's presentation device can be controlled to generate a notification to the user, wherein the notification indicates that a recommended video event is currently available for viewing. The notification can be an active element that allows the user to choose from various options, such as: change the channel and view the recommended content; ignore; record the recommended content; remind me again later; or the like.

In certain embodiments, the control commands identify a plurality of recommended video events, some of which may overlap in time. Accordingly, the process 300 may give the user an opportunity to select from a list of recommended content. The list can be prioritized or ordered according to any desired scheme. For example, the list of recommended content can be ordered based on a score or ranking of predicted user preference. As another example, the list of recommended content can be ordered based on the scheduled broadcast time. In some embodiments, the process 300 automatically records one recommended video event during presentation of another recommended video event. Thus, a second recommended program that overlaps in time with a first recommended program can be recorded in the background (assuming that one or more tuners are available to accommodate the second program) while the user is watching another recommended program. As another option, the process 300 can give the user the option to browse through a plurality of different recommended video events to select one for immediate presentation. In such a scenario, the user can initiate browsing and selecting commands to automatically replace a first recommended video event with a second recommended video event for presentation to the user.

As mentioned above with reference to FIG. 4, user feedback can be used to supplement and modify the recommendation engine. Thus, the process 300 can receive user feedback that is related to the recommended video events (task 314). The user feedback can be generated by a simple “like” button on a remote control, or via a graphical user interface presented to the user. The user feedback can include any amount of information as appropriate to the particular embodiment. For example, the user feedback may indicate whether or not the user agrees with the recommendation, whether or not the user watched the recommended video event, and to what extent. In some embodiments, the user can be prompted to provide a score or rank for each recommended program event, such as a numerical score. In other embodiments, the process 300 allows the user to simply flag interesting content. Regardless of the type or format of the user feedback, the recommendation system/engine processes the received user feedback to update the recommendation or learning algorithm (task 316). Over time, the user feedback can enhance the quality and accuracy of the content recommendations and improve the user experience.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

1. A method of controlling operation of a content receiver device, the method comprising:
receiving user interaction data at a recommendation system, the user interaction data corresponding to content consumption behavior of a user;
processing, with the recommendation system, the user interaction data to identify recommended video events for the user; and
generating, with the recommendation system, control commands to automatically configure a receiver interface of the content receiver device to tune to a designated channel to receive a first recommended video event, and to automatically decode the received first recommended video event for presentation to the user.

2. The method of claim 1, wherein the receiving step receives the user interaction data from the content receiver device.

3. The method of claim 1, wherein the receiving step receives the user interaction data from a media device associated with the user.

4. The method of claim 1, wherein the receiving step receives the user interaction data from a computing device associated with the user.

5. The method of claim 1, wherein the receiving step receives the user interaction data from a streaming media service utilized by the user.

6. The method of claim 1, wherein the receiving step receives the user interaction data from a social media application utilized by the user.

7. The method of claim 1, further comprising:
automatically recording a second recommended video event during presentation of the first recommended video event.

8. The method of claim 1, further comprising:
receiving, at the recommendation system, user feedback related to the first recommended video event; and
updating a recommendation algorithm of the recommendation system in response to the received user feedback.

9. The method of claim 1, further comprising:
processing, with the recommendation system, additional user interaction data corresponding to content consumption behavior of at least one additional user, wherein the recommended video events are identified based on the user interaction data and the additional user interaction data.

10. The method of claim 1, further comprising:
obtaining a command to browse the recommended video events; and
in response to the command, automatically replacing the first recommended video event with a second recommended video event for presentation to the user.

11. The method of claim 1, wherein the first recommended video event comprises a broadcast video event.

12. The method of claim 1, wherein the first recommended video event comprises an on-demand video event.

13. The method of claim 1, wherein the first recommended video event comprises a recorded video event.

14. A video services receiver comprising:
a receiver interface to receive data associated with video services, the data including video data that conveys video events;
at least one decoder module to decode received video data for presentation of video events;
a display interface for a display element operatively coupled to the video services receiver, the display interface facilitating presentation of video content on the display element; and
a processor architecture comprising at least one processor device, wherein the processor architecture cooperates with the receiver interface, the at least one decoder module, and the display interface to:
provide user interaction data to a recommendation engine, the user interaction data corresponding to content consumption behavior of a user;
receive, from the recommendation engine, control commands that identify recommended video events for the user; and
in response to the received control commands, automatically configure the receiver interface to tune to a designated channel to receive a first recommended video event, and automatically configure the at least one decoder module to decode the received first recommended video event for presentation to the user.

15. The video services receiver of claim 14, wherein the recommendation engine is implemented at the video services receiver.

16. The video services receiver of claim 14, wherein the user interaction data includes viewing statistics collected by the video services receiver.

17. The video services receiver of claim 14, wherein the processor architecture cooperates with the receiver interface, the at least one decoder module, and the display interface to:
provide user feedback to the recommendation engine, wherein the user feedback is related to the first recommended video event, and wherein the recommendation engine updates a recommendation algorithm in response to the user feedback.

18. A method of controlling operation of a content receiver device, the method comprising:
providing user interaction data to a recommendation engine, the user interaction data corresponding to content consumption behavior of a user;
processing, with the recommendation engine, the user interaction data to identify a recommended video event for the user;
communicating control data from the recommendation engine to the content receiver device, wherein the control data is associated with the recommended video event; and
in response to receiving the control data at the content receiver device, automatically configuring a receiver interface of the content receiver device to tune to a designated channel to receive the recommended video event, and automatically decoding the received recommended video event for presentation to the user.

19. The method of claim 18, wherein the user interaction data includes usage data related to operation of the content receiver device.

20. The method of claim 18, further comprising:
communicating user feedback to the recommendation engine, wherein the user feedback is related to the recommended video event; and
updating a recommendation algorithm of the recommendation system in response to the received user feedback.
